(19) United States
(12) Patent Application Publication
(10) Pub. No.: US 2007/0141406 A1
(43) Pub. Date: Jun. 21, 2007

(54) Technique and apparatus to detect carbon monoxide poisoning of a fuel cell stack

(76) Inventor: Jing Ou, Latham, NY (US)

Correspondence Address: TROP PRUNER & HU, PC, 1616 S. VOSS ROAD, SUITE 750, HOUSTON, TX, 77057-2631, US

(21) Appl. No.: 11/311,613

(22) Filed: Dec. 19, 2005

(51) Int. Cl. H01M 8/04

(52) U.S. Cl. 429/13; 429/23

(57) ABSTRACT

A technique that is usable with a fuel cell stack includes determining a cell voltage profile of the fuel cell stack and determining an average cell voltage of the fuel cell stack. The technique includes detecting carbon monoxide poisoning of the fuel cell stack based on the cell voltage profile and the average cell voltage.

### BACKGROUND

The invention generally relates to a technique and apparatus to detect carbon monoxide poisoning of a fuel cell stack.

A fuel cell is an electrochemical device that converts chemical energy directly into electrical energy. For example, one type of fuel cell includes a proton exchange membrane (PEM) that permits only protons to pass between an anode and a cathode of the fuel cell. Typically PEM fuel cells employ sulfonic-acid-based ionomers, such as Nafion, and operate in the 60° Celsius (C) to 70° temperature range. Another type employs a phosphoric-acid-based polybenziamidazole, PBI, membrane that operates in the 150° to 200° temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system. For example, the fuel cell system may also include a cooling subsystem to regulate the temperature of the stack, a cell voltage monitoring subsystem, a control subsystem, a power conditioning subsystem to condition the power that is provided by the fuel cell stack for the system load, etc. The particular design of each of these subsystems is a function of the application that the fuel cell system serves.

During the course of its operation, the fuel cell stack may potentially experience an “unhealthy” condition, such as flow channel flooding, membrane drying and fuel starvation. These conditions may negatively affect operation of the fuel cell stack and may potentially damage the stack. Another unhealthy condition occurs when a relatively high level of carbon monoxide is introduced into the stack and “poisons” the stack. Early detection of carbon monoxide poisoning is important for purposes of preventing further stack damage and preventing a shut down of the fuel cell system.

Thus, there exists a continuing need for better ways to detect carbon monoxide poisoning of a fuel cell stack.

### SUMMARY

In an embodiment of the invention, a technique that is usable with a fuel cell stack includes determining a cell voltage profile based on cell voltages of the fuel cell stack and determining an average cell voltage based on the cell voltages. The technique includes detecting carbon monoxide poisoning of the fuel cell stack based on the cell voltage profile and the average cell voltage.

In another embodiment of the invention, a fuel cell system includes a fuel cell stack, and a circuit, voltage monitoring circuit to determine a cell voltage profile of the fuel cell stack and an average cell voltage of the fuel cell stack. A controller is coupled to the cell voltage monitoring circuit to detect carbon monoxide poisoning of the fuel cell stack based on the cell voltage profile and the average cell voltage.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIG. 2 is a flow diagram depicting a technique to detect carbon monoxide poisoning in a fuel cell stack of the fuel cell system of FIG. 1 according to an embodiment of the invention.

### DETAILED DESCRIPTION

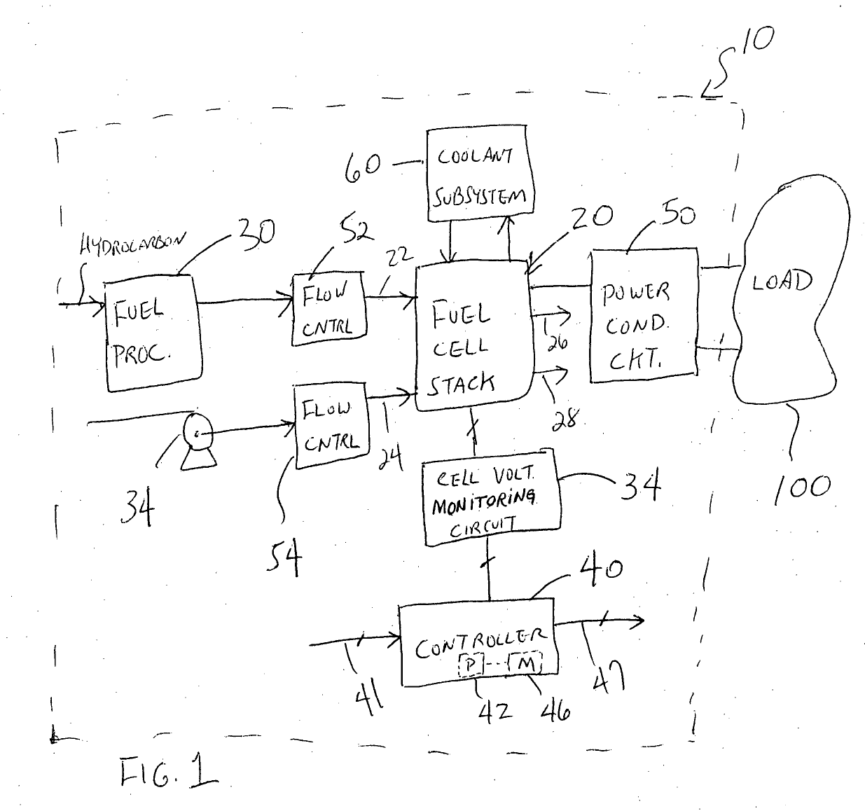

Referring to FIG. 1, in accordance with an embodiment of the invention, a fuel cell system 10 includes a fuel cell stack 20 (a PEM fuel cell stack, for example) that, in response to fuel and oxidant flows produces power for an electrical load 100. Powering conditioning circuitry 50 of the fuel cell stack converts a DC stack voltage of the fuel cell stack 20 into the appropriate voltage (DC or AC, depending on the type of load) for the load 100. For example, the load 100 may be a residential load and, may receive an AC voltage from the fuel cell system 10. However, in other embodiments of the invention, the fuel cell system 10 may provide a “DC” output voltage for the case where the load 100 is a DC load. Other variations are possible and are within the scope of the appended claims.

In accordance with embodiments of the invention, a fuel processor 30 of the fuel cell system 10 receives a hydrocarbon and produces a corresponding fuel flow (called “reformate”) to the fuel cell stack 20. The fuel flow from the fuel processor 30 may pass, for example, through flow control 52 (one or more valves and/or a pressure regulator, as examples) to an anode inlet 22 of the fuel cell stack 20. An air blower 34 may produce an air flow (i.e., the oxidant flow) that passes through oxidant flow control 54 to a cathode inlet 24 of the fuel cell stack 20. The incoming oxidant flow to the fuel cell stack 20 passes through the oxidant flow channels of the fuel cell stack 20 to appear as cathode exhaust at a cathode outlet 28 of the stack 20; and the incoming fuel flow to the stack 20 passes through fuel flow channels of the fuel cell stack 20 and to appear as anode exhaust at an anode outlet 26 of the stack 20.

Depending on the particular embodiment of the invention, the anode exhaust of the fuel cell stack 20 may be partially or totally recirculated; the anode exhaust may be partially or totally furnished to a flare or oxidizer; or alternatively, the anode chamber of the fuel cell stack 20 may be “dead-headed.” Additionally, depending on the particular embodiment of the invention, the cathode exhaust of the fuel cell stack 20 may be recirculated, may be furnished to a flare or oxidizer, etc. Thus, many variations are possible and are within the scope of the appended claims.

It is possible that during the course of the operation of the fuel cell system 10, an unacceptably high level of carbon monoxide (i.e., a level that may damage cells of the fuel cell stack 20) may be present in the fuel cell stack 20. This condition, called “carbon monoxide poisoning,” may progressively damage the cells of the stack over time if the corrective action is not taken. Thus, it is important to detect carbon monoxide poisoning of the stack early on to prevent further cell damage and to prevent a shut down of the fuel cell system 10.

Therefore, in accordance with embodiments of the invention, the fuel cell system 10 performs a technique to detect carbon monoxide poisoning so that timely measures may be taken to prevent stack damage. These measures may, for example, involve controlling the fuel processor 30 or another component of the fuel cell system 10 to reduce the level of carbon monoxide to an acceptable level, shutting down the fuel cell system 10 for service, etc.

In accordance with embodiments of the invention described herein, the fuel cell system 10 monitors the stack's cell voltages to detect carbon monoxide poisoning. The cell voltages are obtained via a cell voltage monitoring circuit 34, a circuit that regularly scans the cell voltages of the fuel cell stack 20 and communicates an indication of the scanned voltages to a controller 40 of the fuel cell system 10. An example of the cell voltage monitoring circuit 34 may be found in U.S. Pat. No. 6,140,820, entitled “Measuring Cell Voltages of a Fuel Cell Stack,” which issued on Oct. 31, 2000. Other embodiments of the cell voltage monitoring circuit 34 are possible and are within the scope of the appended claims.

As further described below, the controller 40 processes the cell voltages to derive a cell voltage profile and an average cell voltage; and from these parameters, the controller 40 is able to detect carbon monoxide poisoning.

The cell voltage profile may be viewed as being a collection of cell voltages of the fuel cell stack 20. The cell voltages of the cell voltage profile may be voltages of selected cells of the fuel cell stack 20, may be the cell voltages for all of the cells of the fuel cell stack 20, may be a reduced set of cell voltages based on a culling criteria, etc., depending on the particular embodiment of the invention.

From the scanned cell voltages that are provided by the cell voltage monitoring circuit 34, the controller 40 also derives an average cell voltage. In accordance with some embodiments of the invention, the average cell voltage may be the average of all of the cell voltages of the fuel cell stack 20, may be the average voltage of a selected group of cell voltages of the fuel cell stack 20, may be the average voltage of a group of cell voltages derived pursuant to a culling procedure (further described below) used by the controller 40, etc.

Based on the average cell voltage and the cell voltage profile, the controller 40 determines whether carbon monoxide poisoning has occurred in the fuel cell stack 20. If carbon monoxide poisoning is detected, the controller 40 takes the appropriate action to prevent further damage to the fuel cell stack 20, such as alerting service personnel (via an alarm noise, electronic message, display panel icon, etc.), shutting down part or all of the fuel cell system 10 and/or controlling the fuel processor 30 or another component of the fuel cell system 10 to reduce the level of carbon monoxide poisoning, depending on the particular embodiment of the invention.

As depicted in FIG. 1, in accordance with some embodiments of the invention, the controller 40 includes a processor 42 (one or more microprocessors and/or microcontrollers, as example) that is coupled to a memory 46 that may, for example, store program instructions to cause the controller 40 to operate as described herein to regularly develop and analyze an average cell voltage and a cell voltage profile for purposes of detecting carbon monoxide poisoning. As also depicted in FIG. 1, the controller 40 may include various input terminals 41 for purposes of receiving status signals, signals indicative of commands, etc. and the controller 40 may include output terminals 47 for purposes of controlling various aspects of the fuel cell system 10, such as controlling motors, valves, communicating messages, generating alarm conditions, etc., depending on the particular embodiment of the invention.

Turning now to more specific details of an exemplary embodiment for detecting carbon monoxide poisoning, in accordance with some embodiments of the invention, the controller 40 relies on the following observations. When a PEM fuel cell stack experiences carbon monoxide poisoning, the voltages of the fuel cell stack 20 drop (the first prong of the carbon monoxide poisoning test); and at the same time, the cell voltage profile of the fuel cell stack shows an up and down pattern: at one moment, some cell voltages go up and other cell voltages go down; and at the next moment, the cell voltages that went down go up and the cell voltages that went up go down. This phenomenon may be labeled “cell voltage dancing.”

Therefore, in accordance with some embodiments of the invention, the controller 40 monitors (via the cell voltage monitoring circuit 34) the fuel cell stack 20 to detect when the average cell voltage decays enough to indicate potential carbon monoxide poisoning. For example, in accordance with some embodiments of the invention, the cell voltage monitoring circuit 34 determines when the average cell voltage drops by approximately 0.05 volts (as an example). Upon this detection, the first prong of the carbon monoxide poisoning test has been satisfied.

For purposes of detecting cell voltage dancing (the second prong of the carbon monoxide poisoning test), in accordance with some embodiments of the invention, the controller 40 determines the standard deviation of the cell voltage profile. Thus, if the standard deviation exceeds a predetermined threshold (a standard deviation of 0.03, for example), then the second prong of the carbon monoxide poisoning test has been satisfied. At this point, the controller 40 concludes that carbon monoxide poisoning is occurring and takes the appropriate action.

For purposes of distinguishing carbon monoxide poisoning from other unhealthy conditions, such as flow channel flooding, membrane drying and fuel starvation (as examples), the controller 40 excludes cell voltages at the upper and lower ends of the range of cell voltages that is spanned by the cell voltage profile. More specifically, in accordance with some embodiments of the invention, the controller 40 excludes the lowest ten percent and highest ten percent of the cell voltages from the cell voltage profile. Thus, by excluding the cell voltages at the extremes, the controller 40 is able to evaluate the general trend of the cell voltage profile.

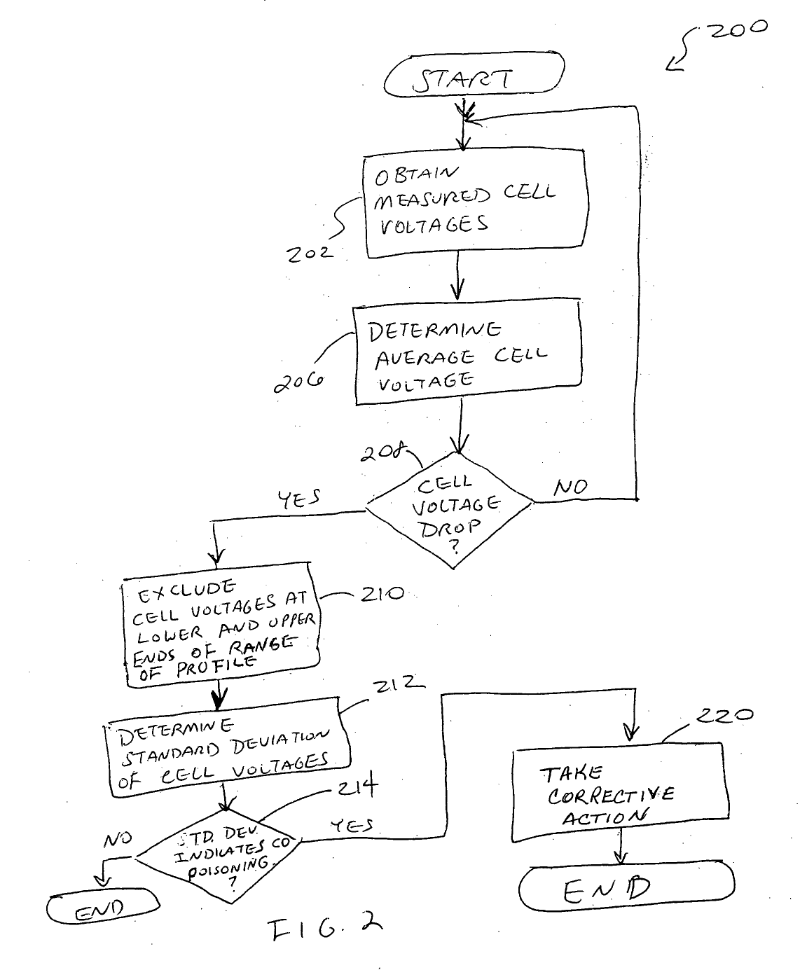

Referring to FIG. 2 in conjunction with FIG. 1, to summarize, in accordance with some embodiments of the invention, the controller 40 performs a technique 200 to detect carbon monoxide poisoning of the fuel cell stack 20. Pursuant to the technique 200, the controller 40 obtains (block 202) measured cell voltages, such as by obtaining scanned cell voltages that are provided by the cell voltage monitoring circuit 34, for example. The controller 40 then determines (block 206) the average cell voltage.

If the controller 40 determines (diamond 208) that a cell voltage drop has occurred, then the first prong of the carbon monoxide poisoning test has been satisfied. Otherwise, control returns to block 202 to continue monitoring the average cell voltage.

If a cell voltage drop has been detected, then, pursuant to the technique 200, the controller 40 excludes (block 210) the cell voltages at the lower and upper ends of the range that is spanned by the cell voltage profile. Using the resulting set of cell voltages, the controller 40 determines (block 212) the standard deviation of the cell voltages of this set. Subsequently, pursuant to the technique 200, the controller 40 determines (diamond 214) whether the standard deviation indicates that carbon monoxide poisoning has occurred. If so, then the controller 40 takes the appropriate corrective action, as depicted in block 220.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell stack, comprising:
determining a cell voltage profile based on cell voltages of a fuel cell stack;
determining an average cell voltage based on cell voltages of the fuel cell stack; and
detecting carbon monoxide poisoning of the fuel cell stack based on the cell voltage profile and the average cell voltage.

2. The method of claim 1, wherein the act of detecting comprises:
detecting carbon monoxide poisoning based on a standard deviation of the cell voltage profile and the average cell voltage.

3. The method of claim 2, further comprising:
determining the standard deviation, the act of determining the standard deviation comprising:
measuring cell voltages of the fuel cell stack, the cell voltages spanning a range; and
excluding cell voltages near the upper and lower ends of the range from the determination of the standard deviation.

4. The method of claim 3, wherein the excluded cell voltages comprise voltages excluded from the cell voltage profile.

5. The method of claim 3, wherein the excluded cell voltages comprise voltages from the top ten percent of the range.

6. The method of claim 3, wherein the excluded cell voltages comprise cell voltages from the bottom ten percent of the range.

7. The method of claim 1, wherein the act of determining the cell voltage profile comprises:
measuring cell voltages of the stack to form a first group of cell voltages that span a range excluding cell voltages near upper and lower ends of the range form the cell voltage profile.

8. The method of claim 7, wherein the act of excluding comprises excluding cell voltages within ten percent of the upper end of the range.

9. The method of claim 7, wherein the act of excluding comprises excluding cell voltages within ten percent of the lower end of the range.

10. The method of claim 1, further comprising:
forming the cell voltage profile to significantly exclude an effect on the cell voltage profile caused by at least one of the following: flow channel flooding, membrane drying and fuel starvation.

11. A fuel cell system comprising:
a fuel cell stack; and
a circuit to determine a cell voltage profile and an average cell voltage based on cell voltages of a fuel cell stack, and detect carbon monoxide poisoning of the fuel cell stack based on the cell voltage profile and the average cell voltage.

12. The fuel cell system of claim 11, wherein the circuit comprises:
a cell voltage monitoring circuit to scan cell voltages of the fuel cell stack; and
a controller to receive an indication of the scanned cell voltages from the cell voltage monitoring circuit, form the cell voltage profile and the average cell voltage, and detect the carbon monoxide poisoning.

13. The fuel cell system of claim 11, wherein the circuit detects carbon monoxide poisoning based on a standard deviation of the cell voltage and the average cell voltage.

14. The fuel cell system of claim 13, wherein the circuit determines the standard deviation, the determination including excluding cell voltages near the upper and lower ends of a range spanned by the cell voltages.

15. The fuel cell system of claim 14, wherein the excluded cell voltages comprise voltages excluded from the cell voltage profile.

16. The fuel cell system of claim 14, wherein the excluded cell voltages comprise voltages from the top ten percent of the range.

17. The fuel cell system of claim 11, wherein the circuit obtains a first group of the cell voltages, the first group spanning a range, and excludes cell voltages near the upper and lower ends of the range to form the cell voltage profile.

18. The fuel cell system of claim 11, wherein the circuit determines the cell voltage profile by measuring cell voltages of the stack to form a first group of cell voltages that span a range excluding cell voltages near upper and lower ends of the range.

19. The fuel cell system of claim 18, wherein the circuit excludes cell voltages within ten percent of the upper end of the range.

20. The fuel cell system of claim 11, wherein the circuit forms the cell voltage profile to significantly exclude an effect on the profile caused by at least one of the following: flow channel flooding, membrane drying and fuel starvation.
